(19) United States
(12) Patent Application Publication
(10) Pub. No.: US 2004/0260705 A1
(43) Pub. Date: Dec. 23, 2004

(54) Cross-domain entity relationship model for managing data related to communications products

(76) Inventor: Pamela Dooley Roman, Birmingham, AL (US)

Correspondence Address: CANTOR COLBURN LLP, 55 GRIFFIN ROAD SOUTH, BLOOMFIELD, CT, 06002, US

(21) Appl. No.: 10/602,250

(22) Filed: Jun. 23, 2003

(51) Int. Cl. G06F 17/60

(52) U.S. Cl. 707/100

(57) ABSTRACT

An embodiment of the invention is a method of managing data related to communications products. The method includes defining a contract domain including a contract entity having attributes of an agreement between a customer and a provider of a communications product. A product domain is defined including a product entity having attributes, of the communications product. A location domain is defined including a location entity having attributes of a geographic location. An account receivables domain is defined including an account entity having attributes of a customer account. A customer domain is defined including a party entity having attributes of a party. Within the customer domain, a contract instance of the contract entity, a product instance of the product entity, a location instance of the location entity and an account instance of the account entity are defined.

### BACKGROUND OF THE INVENTION

The present invention relates generally to data management and in particular to a cross-domain entity relationship model for managing data related to communications products.

Communications service providers offer a number of different products to consumers, businesses, etc. The products may include physical products (e.g., modems, mobile phones) or service-based products (e.g., calling plans, ISP plans). In conventional systems, much of the data about the products that have been sold to customers is retained in legacy billing systems. This data is organized and structured primarily to facilitate billing, and secondarily to support service order processing.

This hierarchical account structure hampers the ability to implement new business processes. For example, it is very difficult to obtain a comprehensive view of a large business customer. The products purchased by the customer may be spread among multiple accounts in various billing locations. To further complicate matters, identifiers that would link these accounts are manually administered and generally unreliable. Thus, there is a need for improved management of data related to communications products.

### SUMMARY OF THE INVENTION

An embodiment of the invention is a method of managing data related to communications products. The method includes defining a contract domain including a contract entity having attributes of an agreement between a customer and a provider of a communications product. A product domain is defined including a product entity having attributes of the communications product. A location domain is defined including a location entity having attributes of a geographic location. An account receivables domain is defined including an account entity having attributes of a customer account. A customer domain is defined including a party entity having attributes of a party. Within the customer domain, a contract instance of the contract entity, a product instance of the product entity, a location instance of the location entity and an account instance of the account entity are defined.

### BRIEF DESCRIPTION OF THE DRAWINGS

Referring to the exemplary drawings wherein like elements are numbered alike in the accompanying Figures:

FIG. 1 is a block diagram of an exemplary system for implementing the invention;

FIG. 2 depicts an exemplary database model;

FIG. 3 depicts exemplary product instance relationships.

### DETAILED DESCRIPTION OF THE INVENTION

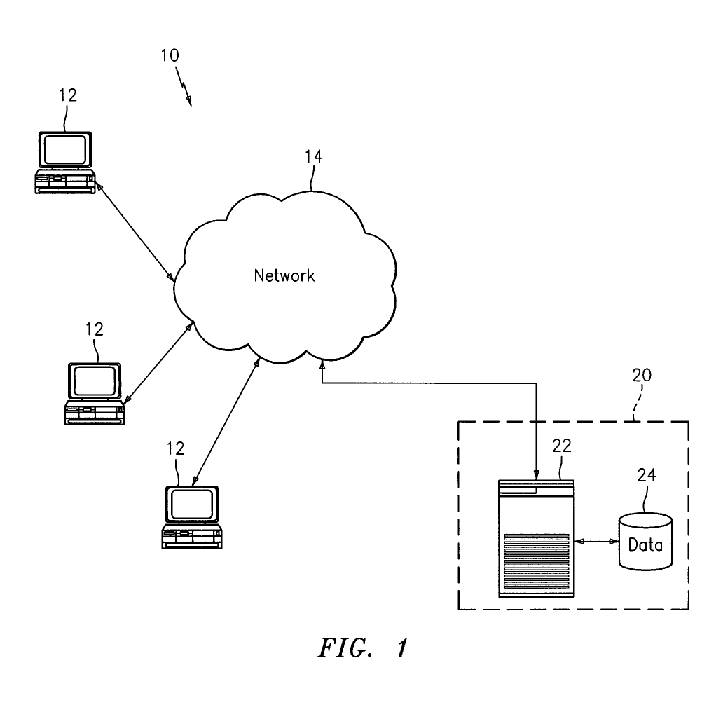

FIG. 1 is a block diagram of an exemplary system 10 for managing data related to communications products and providing access to such data. System 10 includes a number of user terminals 12 operated by users desiring access to data related to communications products. The user systems 12 may be implemented using general-purpose computers executing a computer program for carrying out the processes described herein. Alternatively, user systems 12 may be implemented using devices programmed primarily for accessing network 14 such as a dumb terminal. Further, the user systems 12 may be portable devices such as PDAs, cell phones, etc. User systems 12 are coupled to network 14 which may be any type of known network including a local area network (LAN), wide area network (WAN), global network (e.g., Internet), intranet, virtual private network (VPN), etc. User systems 12 may be physically located in geographically disperse locations.

The user systems 12 are coupled to a database system 20 including a server 22 and a database 24. Database 24 may be a part of server 22, a separate device, or a collection of multiple devices accessible by server 22. The user systems 12 may be coupled to the database system 20 through multiple networks (e.g., intranet and Internet) so that not all user systems 12 are coupled to the database system 20 by the same network. One or all of the user systems 12 and database system 20 may be connected to the network 14 in a wireless fashion and network 14 may be a wireless network.

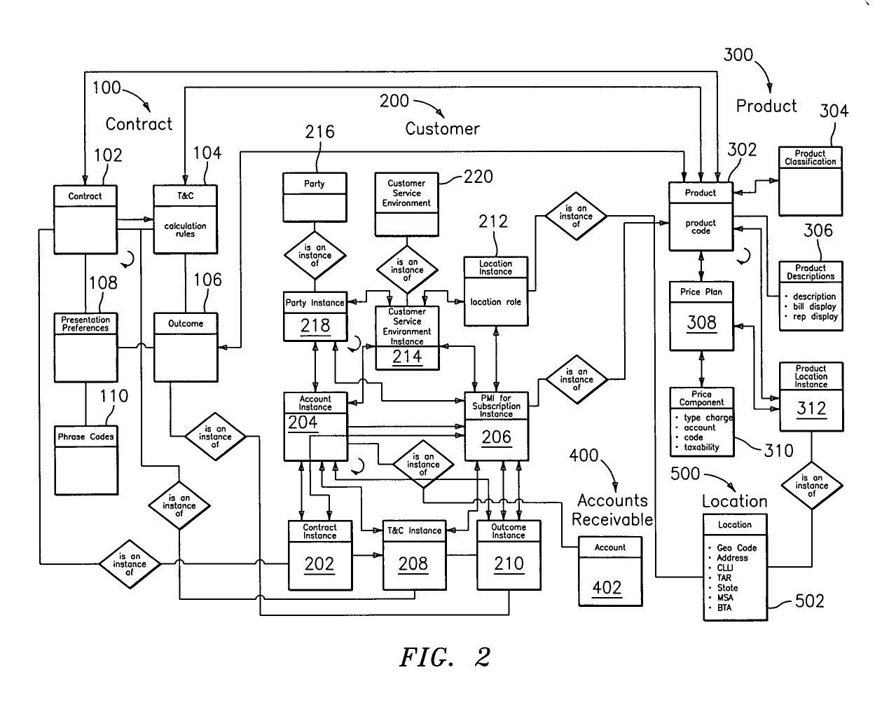

Database 24 contains data related to communications products (physical and/or service-based) arranged across a number of domains. FIG. 2 illustrates an exemplary database model including cross-domain entities. Five domains are shown in FIG. 2, namely a contract domain 100, customer domain 200, product domain 300 accounts receivable domain 400 and a location domain 500.

A domain is a logical set of information, generally aligned with a discrete business process. An entity is a set of information within a domain. Entities include groups of attributes (a specific piece of information, such as a product code). Examples of attributes are provided herein. An instance represents an instantiation of an entity. The database model of FIG. 2 does not reflect the physical database design, nor does it advocate the number of physical databases used. The model also captures relationships that exist between instances of the entities. The relationships between instances may be maintained within the customer domain 200.

The contract domain 100 describes data related to contracts between the customer and the provider of the products. A contract entity 102 reflects an agreement between the customer and the provider for the product. The contract entity 102 need not store the contract document, but the data that is abstracted from a contract. Contract entity 102 includes general information about the contract, such as the contract number, start date, stop date. For example, a customer may negotiate a special price for products based upon some term. A contract is defined as a recursive entity since one contract may be composed of other contracts. The contract entity is directly related, across domains, to product entity 302, and may be related to multiple products.

The contract entity 102 may include a number of attributes. When a contract is negotiated with the customer, a contract instance 202 is defined which is related to an account instance 204, a product instance 206 (also referred to as a Purchased Marketable Item (PMI) Subscription Instance) and a terms and conditions instance 208. Exemplary contract attributes include contract identifier, contract length in months, penalty to date, reward to date, etc.

A terms and conditions entity 104 describes the terms and conditions of a contract. The terms and conditions entity 104 is directly related, across domains, to product entity 302, and may be related to multiple products. A contract may have multiple terms and conditions. When a contract is created, a terms and conditions instance 208 is defined in customer domain 200 and is related to the product instance 206 and an outcome instance 210.

The terms and conditions entity 104 may include a number of attributes. For example, one attribute may be that the product must be retained for 36 months in order for a special price to apply. Additional terms and conditions attributes include whether the terms and conditions are based on revenue or quantity, the number of months the terms and conditions will be effective, a lifetime reward cap amount for the life of terms and conditions, a threshold at which the terms and conditions should be terminated.

An outcome entity 106 describes the consequences of the terms and conditions. The terms and conditions entity 104 is related to the outcome entity 106 and a terms and conditions attribute may have multiple outcomes. Also, outcome entity 106 is directly related, across domains, to product entity 302, and may be related to multiple products.

An outcome attribute may be either a positive or negative consequence. For example, if the product is not retained for 36 months, the outcome is an increase in the price of the product. Additional exemplary outcome attributes include whether to permit a termination penalty to be waived, apply a reward to a bill, and whether to apply a discount on a product.

A presentation preferences entity 108 represents the circumstances under which verbiage will be displayed, and in what order, to customer service representatives, on the bill, on notices to the customer, etc. The presentation preferences entity 108 is related to the contract entity 102 and the outcome entity 106. Multiple presentation preferences may be applicable to a single notice.

A phrase codes entity 110 describes the literal verbiage to be displayed in a notice represented by a code. An alphanumeric code defines certain verbiage. For example, code 256 may define “Reward for service retention”. The phrase codes entity 110 is related to the presentation preferences entity 108.

The product domain 300 includes entities describing the products offered by the company. The product entity 302 represents a product. This is defined as a recursive relationship since a product may be composed of other products (a package or a bundle). Contract entity 102, terms and conditions entity 104, outcome entity 106, and product classification entity 304 may be related to multiple products in product entity 302.

Products are defined in the product entity 302. When the customer purchases a product, this defines a product instance 206 in customer domain 200 and is related to account instance 204. A product instance represents something that has been sold (or provided at no charge) to a customer and can be uniquely identified. Exemplary product attributes include product codes (e.g., USOC), start sell date and stop sell date.

A product is a marketable item and may describe a single item, such as call forwarding, or bundled offerings in a package. A product can be sold stand-alone or offered as part of a package. When a product is combined with others into a package, it is referred to as a feature. Not all features are products (i.e., not available for stand-alone purchase). A product that is a package could actually be comprised of other packages combined with stand-alone products. Some packages are sold as a fixed set of features while others may allow a la carte choice from a set of features. A product catalog will provide the list of marketable items and related features.

Not all products sold to customers will be captured in the product instance. Explicitly purchased products will appear in the product instance. For example, a customer subscribes to call waiting at the time local service is established. The customer is billed a recurring charge for this product and a product instance representing call waiting is retained and related to the customer's billing account. Other products are purchased implicitly. For example, a customer activates call trace and is charged per use. No product instance is retained in the product installed base for this product.

The product classification entity 304 contains various classifications of a product. Such product classification attributes include business unit owner (large business, consumer, small business, wireline, information services, etc.), business unit permitted to sell, sales channel, etc. A product may have multiple product classifications. The product classification entity 304 is related to the product entity 302.

The product descriptions entity 306 represents various descriptions related to a product. Such descriptions include the product name used by an administrator, the product name to be displayed for a customer service representative, the product description to be printed on a bill, product benefits, etc. A product may have multiple product descriptions. The product descriptions entity 306 is related to the product entity 302.

The price plan entity 308 represents the price to be charged for a product based on various qualifiers. A price plan may be related to multiple products in product entity 302. This permits a product to be offered under many names, but at the same price. A product may have multiple price plans. For example, certain customers qualify for product “x” at price plan “y”. Exemplary price plan attributes include the price plan date calculation method (e.g., start billing on service effective date or start billing with next bill) and price plan qualifiers (e.g., residence, business, state, tariff, MSA, BTA, etc.).

The price component entity 310 represents the types of charges that apply for a price plan and is related to the price plan entity 308. Multiple price components may be related to a price plan and/or price component may be related to multiple price plans. For example, price plan “y” includes a monthly recurring type of charge as well as a one-time service establishment type of charge. Exemplary price component attributes include monthly recurring charge type, non-recurring charge type, discount amount, discount percentage, etc.

The account receivables domain 400 includes an account entity 402. The account entity 402 represents an account receivable. The account is the target for all charges to the customer, as well as credits (adjustments, payments, etc.). An account is created for the customer and becomes an account instance 204 in customer domain 200. The account instance is related to the product instance 206 and to the contract instance 202. Exemplary account attributes include previous balance due (carry over balance from last month), balance due, total payments and adjustments for month and final bill amount.

The location domain 500 describes the various geographical locations that are significant for the business. Exemplary location attributes include state, street address, MSA, BTA, geographic codes, taxing area (TAR) codes, CLLI codes, county, local serving office, foreign serving office, service address, billing address. A product location instance 312 is defined in product domain 300 and describes the service address where the product exists. The product location instance 312 is related to the product entity 302. A customer location instance 212 is defined in customer domain 200 and describes the customer address. The customer location instance 212 is related to the product instance 206 and a customer service environment instance 214.

The customer domain 200 represents data about parties and is the domain in which the relationships between various entity instances are created and maintained. For example, a contract may apply to an account. The relationship between a specific contract and a specific account is reflected in this model by the relationship between the entities and instances. This is represented as contract instance 202 being related to account instance 204.

The party entity 216 represents any party that has a relationship with the provider of the products. Examples of a party include an individual, a corporation, an existing customer or a potential customer. A party instance 218 is created and related to the account instance 204, customer service environment instance 214 and product instance 206. Exemplary party attributes include contact name, contact number, contact extension number, other business number, home office number, home office extension, principle owner name, principle owner residence number, principle owner title, principle owner beeper number, principle owner beeper code and principle owner cell phone number.

The customer service environment entity 220 represents information gathered from a customer that, while not maintained or serviced by the company, is relevant to that customer or the products purchased from the provider. For example, although the provider does not sell modems, it may add value to be aware that the customer has a 56K modem and uses that to access the provider network. When such information is gathered, a customer service environment instance 214 is defined. Customer service environment instance 214 may have a many-to-many relationship with party instance 218, customer location instance 212, account instance 204 and product instance 206. Exemplary customer service environment attributes include pre-assigned circuit Id, destination DLCI, existing Internet connection, source E164 address, manufacturer number of the CSU/DSU equipment, serial number of the CSU/DSU equipment, name of the CSU/DSU equipment vendor and IP Address of the host.

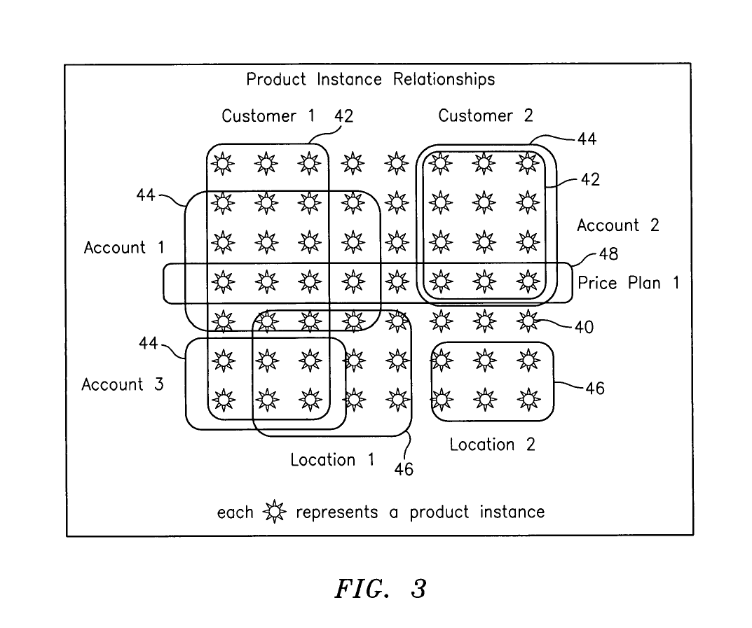

The cross-domain relationships of FIG. 2 provide for enhanced views of data related to communications services. FIG. 3 depicts exemplary views of product instances 40. Customer-oriented views 42 provides a view of the customer, as described by the products purchased from the provider. The relationships between product instances also represent various levels of the customer's hierarchy. Account-oriented views 44 support billing processes. There may be multiple accounts per customer (based upon the customer's preferences). Location-oriented views 46 provide information for pricing of products (e.g., a product is more expensive in Atlanta than Birmingham). Tax jurisdiction is determined based on location. Location information is used for repair and other support functions, especially for ensuring business continuity.

The organization of the data also facilitates price-plan views 48. Relationships across domains identify product instances that contribute to a discount plan or contract service level. A product instance may contribute to multiple price plans. A given price plan may involve product instances that “belong” to otherwise-unrelated accounts or customers.

As described above, the present invention can be embodied in the form of computer-implemented processes and apparatuses for practicing those processes. In an exemplary embodiment, the invention is embodied in computer program code executed by a server. The present invention may be embodied in the form of computer program code containing instructions embodied in tangible media, such as floppy diskettes, CD-ROMs, bard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method of establishing data domains and cross-domain relationships for managing data related to communications products, the method comprising:
defining a contract domain including a contract entity having attributes of an agreement between a customer and a provider of a communications product;
defining a product domain including a product entity having attributes of the communications product;
defining a location domain including a location entity having attributes of a geographic location;
defining an account receivables domain including an account entity having attributes of a customer account;
defining a customer domain including a party entity having attributes of a party;
defining within said customer domain a contract instance of said contract entity, a product instance of said product entity, a location instance of said location entity and an account instance of said account entity;
wherein an entity in one of said contract domain, product domain, location domain, account receivables domain and customer domain is directly related to another entity in another one of said contract domain, product domain, location domain, account receivables domain and customer domain.

2. The method of claim 1 wherein:
said contract entity is directly related to said product entity.

3. The method of claim 1 wherein:
said contract domain includes a terms and conditions entity having attributes of the terms and conditions of a contract;
said terms and conditions entity is directly related to said product entity.

4. The method of claim 3 further comprising:
defining within said customer domain a terms and conditions instance of said terms and conditions entity.

5. The method of claim 1 wherein:
said contract domain includes an outcome entity having attributes of the outcome of a contract;
said outcome entity is directly related to said product entity.

6. The method of claim 5 further comprising:
defining within said customer domain an outcome instance of said outcome entity.

7. A cross-domain data model for managing data related to communications products, the cross-domain data model comprising:
a contract domain including a contract entity having attributes of an agreement between a customer and a provider of a communications product;
a product domain including a product entity having attributes of the communications product;
a location domain including a location entity having attributes of a geographic location;
an account receivables domain including an account entity having attributes of a customer account;
a customer domain including a party entity having attributes of a party, within said customer domain a contract instance of said contract entity, a product instance of said product entity, a location instance of said location entity and an account instance of said account entity;
wherein an entity in one of said contract domain, product domain, location domain, account receivables domain and customer domain is directly related to another entity in another one of said contract domain, product domain, location domain, account receivables domain and customer domain.

8. The cross-domain data model of claim 7 wherein:
said contract entity is directly related to said product entity.

9. The cross-domain data model of claim 7 wherein:
said contract domain includes a terms and conditions entity having attributes of the terms and conditions of a contract;
said terms and conditions entity is directly related to said product entity.

10. The cross-domain data model of claim 9 further comprising:
within said customer domain a terms and conditions instance of said terms and conditions entity.

11. The cross-domain data model of claim 7 wherein:
said contract domain includes an outcome entity having attributes of the outcome of a contract;
said outcome entity is directly related to said product entity.

12. The cross-domain data model of claim 11 further comprising:
within said customer domain an outcome instance of said outcome entity.
